(19) United States
(12) Patent Application Publication
(10) Pub. No.: US 2013/0185800 A1
(43) Pub. Date: Jul. 18, 2013

(54) ANTI-VIRUS PROTECTION FOR MOBILE DEVICES

(71) Applicant: PERLEGO SYSTEMS, INC., Issaquah, WA (US)

(72) Inventors: Curt Miller, Sammamish, WA (US); Paul Davis, Issaquah, WA (US); Greg Martin, Kirkland, WA (US); Steve Wood, Sammamish, WA (US)

(73) Assignee: PERLEGO SYSTEMS, INC., Issaquah, WA (US)

(21) Appl. No.: 13/730,064

(22) Filed: Dec. 28, 2012

Related U.S. Application Data
(60) Provisional application No. 61/582,116, filed on Dec. 30, 2011.

(51) Int. Cl. G06F 21/56

(52) U.S. Cl. CPC G06F 21/568
USPC 726/24

(57) ABSTRACT

A computing device, machine-readable medium, and method associated with identifying viruses on a mobile device are disclosed. In embodiments, a computing device may include a communication interface, one or more storage media containing instructions, and a processing unit coupled to the communication interface and the one or more storage media. The instructions, when executed by the processor, may configure the computing device to analyze files, received by the computing device, for the presence of a virus. The instructions, when executed by the processor, may further notify the mobile device when the presence of a virus is detected.

### CROSS REFERENCE TO RELATED APPLICATIONS

This application claims the benefit of U.S. Provisional Application No. 61/582,116 filed on Dec. 30, 2011, and entitled ANTI-VIRUS PROTECTION FOR MOBILE DEVICES, the subject matter of which is incorporated herein by reference.

### BACKGROUND

With advances in technology, computing is increasingly wireless, mobile, and converging with telephony. With advances in capabilities, increasingly, wireless mobile computing devices have emerged as the primary computing or communication devices for many users. With the increase in usage and reliance, notwithstanding advances in battery technology and power consumption, and therefore extended duration of operation, remain an important subject for wireless mobile devices, such as, but not limited to, smartphones.

With increased usage and capabilities, unlike e.g., earlier pager devices, today's wireless mobile devices typically have a lot more data and applications, and are more vulnerable to virus infections. Anti-virus applications running on wireless devices typically consume large amounts of power. For example, many anti-virus applications utilize the Central Processing Unit (CPU) of the wireless device for analyzing the files to determine if they match any virus signatures provided by the anti-virus provider. Further compounding the problem, if there is a signature file update, all files on the wireless device may need to be rescanned to determine if they match the new signatures.

### BRIEF DESCRIPTION OF THE DRAWINGS

FIG. 1 is a high level block diagram of a client device and a server, in accordance with various embodiments of the present disclosure.

FIG. 2 is a block diagram of an example client device, in accordance with various embodiments of the present disclosure.

FIG. 3 is a block diagram of modules/systems associated with the server, in accordance with various embodiments of the present disclosure.

FIG. 4 illustrates an example computing system/device suitable for use as a client device and/or server to practice various aspects of the invention, in accordance with various embodiments of the present disclosure.

### DETAILED DESCRIPTION OF EMBODIMENTS

Embodiments of this application describe systems and methods for provision of anti-virus services, having particular application to wireless computing devices, such as but not limited to smartphones. In embodiments, the anti-virus services may be provided in conjunction with backup and restoration services.

For example, files including programs and other data in a client such as a wireless mobile device may be transmitted to a server via a wireless connection. In embodiments, the files may be transmitted from a wireless mobile device to the server for back up. In embodiments, the files may then be analyzed/scanned by the server to check for viruses and/or repair damage done by the viruses by performing one or more remedial actions. In embodiments, the server may notify the user that an infection has occurred and/or identify which files may be infected. In one embodiment, the server may have an older back up of the file that is free of virus infection, and restore the infection free, clean version of the file to the wireless mobile device if desired. In embodiments, a versioning file store may be used to restore a recent clean version of the file rather than an infected version. Embodiments may move heavy processing work from the client mobile device to the server having fewer limitations, thereby providing more security to the client mobile device without consuming more energy and reducing operation duration between battery charges, or requiring larger capacity of battery to provide equivalent operation duration.

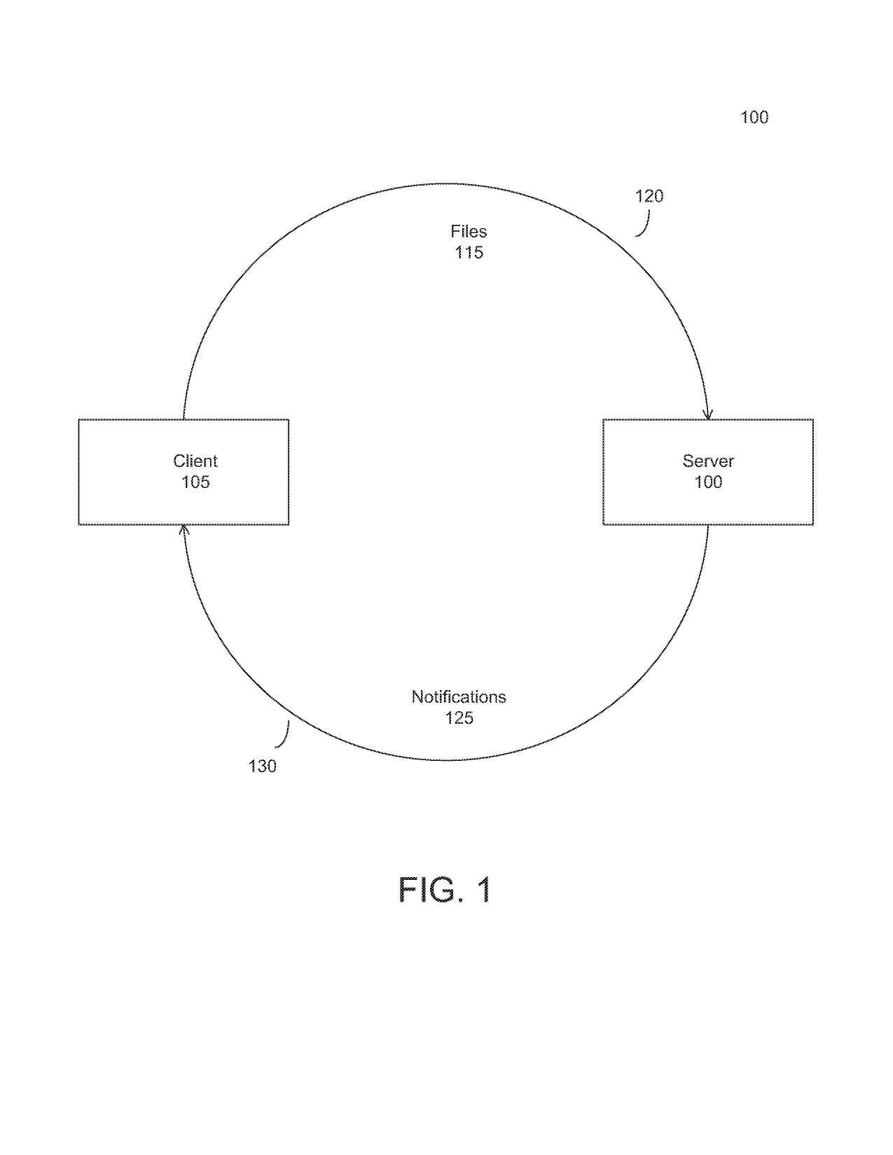

FIG. 1 is a simplified block diagram of an exemplary wireless anti-virus system 100 for providing anti-virus services via a wireless network and/or other networks to a client device such as a wireless device 105 in accordance with various embodiments of the present disclosure. Wireless device 105 may include, for example, but not be limited to, a tablet device, a mobile computer, a personal digital assistant (“PDA”), or a mobile or cellular phone, e.g. smart phone. In general, wireless device 105 has computing capabilities and may be any form of device capable of communicating with anti-virus server 110. An exemplary communication interaction shown in FIG. 1 may include wireless device 105 transmitting files 115 along a path over the air, denoted by arrow 120, to an anti-virus server 110 for analysis and/or scanning of files 115.

Note that in embodiments, prior to wireless device 105 transmitting files 115, wireless device 105 may send and/or receive log-in information (not shown) to and from the anti-virus server 110. Such log-in information may be of any of the conventional forms of log-in/authentication information communications known to those of ordinary skill in the art (e.g., username and password, cryptographic tokens, certification verifications, etc.). Furthermore, note that various preferences may be set and/or updated prior to wireless device 105 transmitting files 115 to anti-virus server 110. In embodiments, anti-virus services may coincide with backups of files. In embodiments, anti-virus services may be provided on a regular basis and/or on demand by a user.

In embodiments, anti-virus server 110 may perform various services for the user. In embodiments, anti-virus server 110 may back up files 115 in addition to scanning files 115 for viruses. Note that in various embodiments, anti-virus server 110 may utilize any suitable method to analyze and/or scan files 115 for viruses. In embodiments, analyzing files 115 may include comparing files 115 or information received with information about known viruses in a virus database or dictionary in order to match a sequence of bits that may identify a particular virus, e.g., a virus signature. In another embodiment, analyzing or scanning a file may include analyzing the file for suspicious instructions, algorithms or patterns. Note that the preceding are merely examples and any suitable methods of virus detection and/or repair may be utilized. In embodiments, the file may be deleted, quarantined, or repaired by restoring the file. Note that the term “virus” as used herein (including the claims) is used generally and without regard to a code's ability to replicate itself and may also include for example, but not limited to, malicious software (“malware”) such as adware, spyware, Trojan Horses, worms, etc.

In embodiments, once anti-virus services have been provided, anti-virus server 110 may transmit notifications 125 to wireless device 105. Notifications 125 may include information related to results of the anti-virus services. In embodiments, notifications 125 may include viruses found and/or actions taken in response to viruses. As noted above, this may include repair of an infected file or restoration of a clean file, or simply notification of the infected files and inquiry or authorization as to a next action. Notifications 125 may also include a number of files scanned and/or backed up and a status of such files and/or when a next anti-virus service may be provided.

In some embodiments, anti-virus server 110 may analyze files 115 transmitted, by wireless device 105, to the anti-virus server to determine whether at least one of the files 115 is infected by a virus. In response to a determination, by anti-virus server 110, that at least one of the files 115 is infected by a virus, the anti-virus server may perform one or more remedial actions.

In some embodiments, the remedial actions may include transmission, by anti-virus server 110, of notification 125 informing the mobile device that at least one of the files 115 is infected by a virus. In some embodiments, notification 125 may cause the mobile device to disable usage and/or execution of at least one of the files 115 determined to be infected by a virus.

In some embodiments, notification 125 may include a clean version of at least one of the files determined to be infected by a virus. The notification may also include instructions that cause wireless device 105 to replace the at least one infected file with the clean version transmitted by anti-virus server 110. In some embodiments, the clean version is retrieved from a previous back up of the one or more files 115 determined to be infected by a virus. In some embodiments, the clean version is generated by disinfecting the one or more files 115 determined to be infected by a virus when a clean backup is not available.

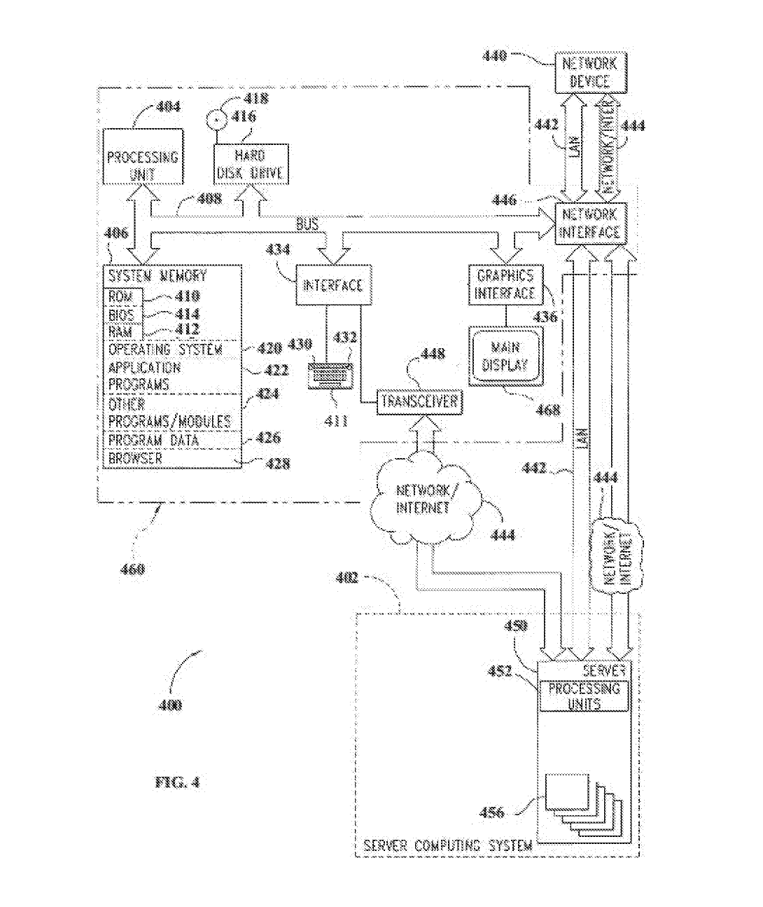

Note that anti-virus server 110 may function in a distributed computing environment that includes a plurality of wireless devices 105, interconnected by a wireless network via a gateway to other networks to anti-virus server 110. The connections and communications may be interconnected via suitable network connections using suitable network communications protocols. As will be appreciated by those of ordinary skill in the art, the anti-virus server 110 may reside on any device accessible by the mobile device 105 shown in FIG. 1. It will also be appreciated that while the anti-virus server 110 of the anti-virus system 100 is illustrated as a single device, the anti-virus server 110 may actually comprise more than a single device in an actual system practicing embodiments of the present invention. It will also be appreciated that the anti-virus server 110 may also provide back up and thus may include file servers, database servers or a mixture of file servers and database servers. An exemplary anti-virus server 110 is shown in detail in FIG. 4.

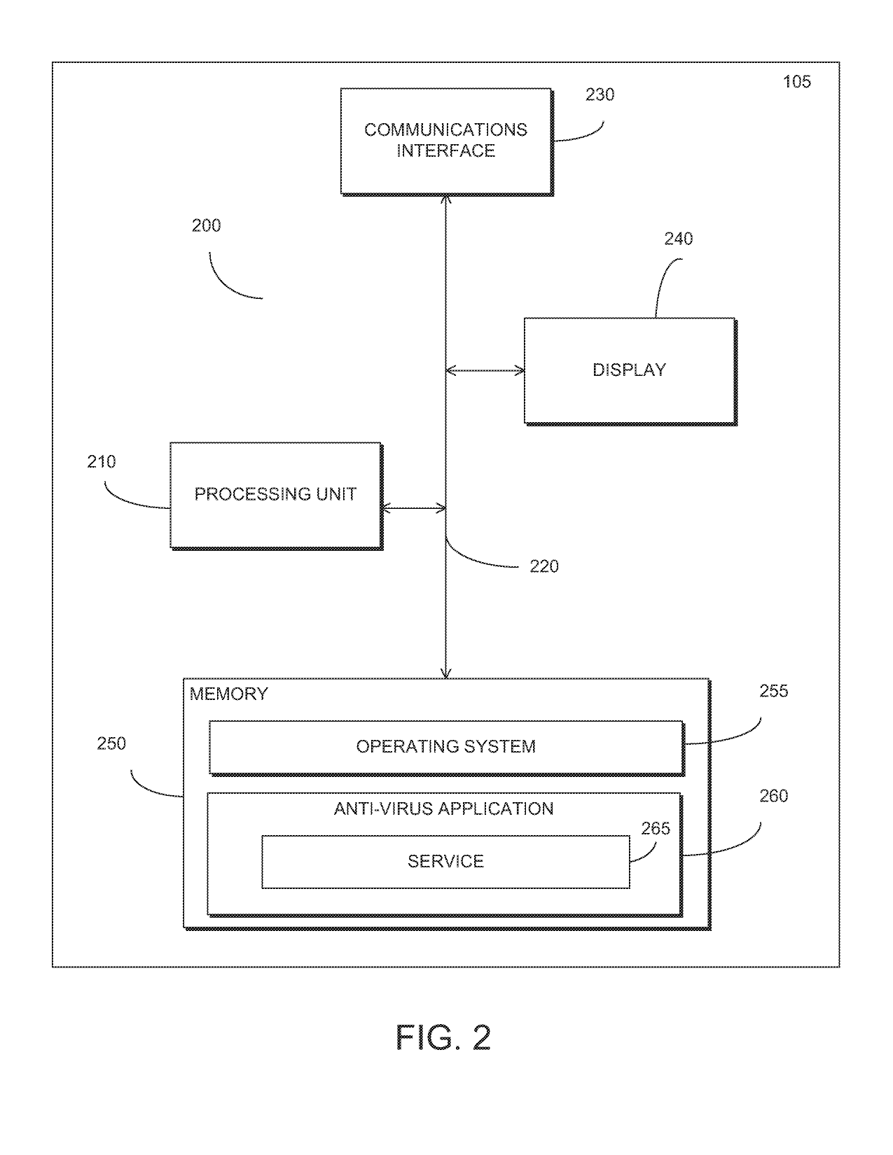

FIG. 2 illustrates an exemplary client device, e.g., wireless device 105, suitable for use in embodiments of the present invention. Those of ordinary skill in the art and others will appreciate that the wireless device 105 may include many more components than those shown in FIG. 2. However, it is not necessary that all of these generally conventional components be shown in order to disclose an enabling embodiment for practicing the present invention. As shown in FIG. 2, the wireless device 105 includes a communications interface 230 for connecting to remote devices. Those of ordinary skill in the art will appreciate that the communications interface 230 includes the necessary circuitry, driver and/or transceiver for such a connection, and is constructed for use with the appropriate protocols for such a connection. In one embodiment of the present invention, the communications interface 230 includes the necessary circuitry for a wireless network connection. Examples of wireless network connection may include, but are not limited to, WiFi, 3G/4G, and so forth.

The computing device 200 also includes a processing unit 210, a display 240 and a memory 250, all interconnected along with the communications interface 230 via a bus 220. Processing unit 210 may be any one of a number of single or multi-core processors known in the art. Display 240 may likewise be any of a number of display devices known in the art, including, but not limited to, flat panel displays, touch-sensitive displays and so forth. Those of ordinary skill in the art and others will appreciate that the display 240 may not be necessary in all forms of wireless computing devices and accordingly is an optional component. The memory 250 generally comprises a random access memory (“RAM”), a read only memory (“ROM”), or other volatile memory, and a permanent or persistent mass storage device, such as a disk drive, a solid state drive, and so forth. The memory 250 may be configured to store an operating system 255 and backup and anti-virus application or software 260 formed in accordance with embodiments of the present invention. Operating system (OS) 225 may be any one of a number of OS known in the art, e.g., iOS from Apple Computer, or Window 7 from Microsoft Corporation. It will be appreciated that software components may be loaded from a computer readable medium into memory 250 of the client device 200 using a drive mechanism (not shown) associated with the computer readable medium, such as a floppy, tape or DVD/CD-ROM drive or the communications interface 230.

Although an exemplary wireless device has been described that generally conforms to conventional computing devices, those of ordinary skill in the art and others will appreciate that wireless device 105 may be any of a great number of computing devices capable of communicating remotely with other computing devices. In various embodiments of the present invention and as noted above, mobile device 105 may be a PDA, general purpose computing device, smart phone, tablet, and the like.

In embodiments, application 260 may include a configuration portion that allows a user to enter account information and specify default application behaviors such as how the anti-virus server 110 should respond to files that have been flagged as infected. In an embodiment, application 260 may include a configuration portion that may control when, and which, files may be sent to anti-virus server 110 for backup and/or analysis/processing. In embodiments, as noted previously, files may be sent on a regularly scheduled basis or, in other embodiments, on a schedule determined by anti-virus server 110. Application 260 may, in embodiments, include a control portion that may allow the user to trigger a manual scan at any time. In embodiments, a control portion may define when to do a scheduled analysis of the device. In embodiments, application 260 may be associated with or run a service 265 that may be configured to perform a number of functions. In embodiments, service 265 may run in the background and watch for file additions, changes or deletions. In an embodiment, service 265 may be configured to send modified/changed files to anti-virus server 110 via communications interface 230. Service 265 may also, in embodiments, watch for changes in network connection status. In embodiments, service 265 may watch for low battery conditions and/or connection or status of connection to a power source. In embodiments, service 265 may watch for alerts from anti-virus server 110.

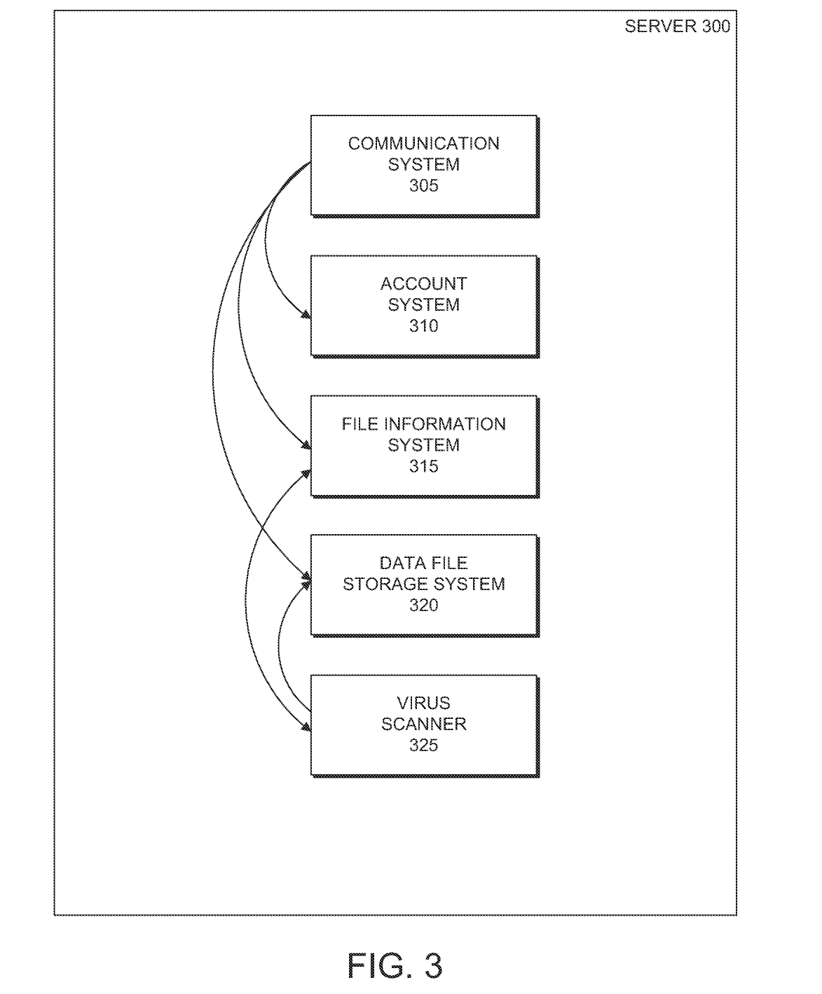

FIG. 3 illustrates an exemplary server system 300 in accordance with embodiments. In embodiments, server system 300 provides a majority of the processing and analysis associated with detecting viruses in the received files 115. In the embodiment shown, server 300 may include modules or systems such as a communications systems 305, account system 310, file information system 315, data file storage system 320, and virus scanner system 325. In embodiments, communications systems 305 may communicate with a client such as wireless device 105 and in one embodiment may be configured to validate user account information. In embodiments, communications systems 305 may be configured to receive or accept files from wireless device 105 as well as send notifications including alerts to wireless device 105. In one embodiment, communications systems 305 may provide information to account system module 310. In embodiments, account system module 310 may store user information including but not limited to wireless device 105 identity information as well as general wireless device 105 information.

In embodiments, communications systems 305 may also provide information to file information system 315. In embodiments, file information systems 315 may include a device image storage that stores information about files on wireless device 105. For example, file information system 315 may include information on file characteristics, e.g., name, path, size, creation date, and signature. File information system 315 may also include information related to where a subject file is located in the file store or when the subject file was added and deleted. In embodiments, in the case of a manual backup, descriptive information about the backup may be stored in file information system 315.

In embodiments, communications systems 305 may also provide data or information to be stored in data file storage system 320. In embodiments, data file storage system 320 may contain an image of each file sent to the server. Note that in one embodiment, a file may be stored only once. In embodiments, multiple device images can point to the same file. For example, files of the same application from different wireless mobile devices may point to the same saved copy of the application file, shared among the devices. In embodiments, a virus state may be stored as well as when a file was last scanned and which signature file was used. In embodiments, a virus scanner 325 may receive information/data/files from file information system 315 and/or data file storage system 320. In embodiments, virus scanner 325 may manages virus definitions. In embodiments, virus scanner 325 may also scan new files added to file storage system 320 and/or scan some or all files when definitions are updated. In an embodiment, virus scanner 325 may report to one or more of the other modules or systems when a suspicious file is found.

In embodiments, a processing of a single file may demonstrate important aspects of the system. In embodiments, according to a first example where a file is new to the system, a new file may be created on or copied to the client or wireless device 105. For example, this may include a user taking a picture, downloading a new application, or any other creation or copying of a file. In embodiments, a source of the file may not be important. In embodiments, wireless device 105 may perform initial processing on the file. This may include gathering a name, path, size, creation date, and generating a signature. In embodiments, the purpose of the signature may be to detect subtle changes to a file that might not change the size of a file and to make it easy for the server to tell if two versions of a file are identical without doing a bit-wise comparison. Example signatures could be CRCC, MD-5 or SHA-1. In embodiments, client 105 takes the information gathered and sends it to anti-virus server 110 for analysis. In embodiments, anti-virus server 110 may receive the information and determine if it has a copy of the file by checking file storage system 320. In the current example, no matching copy of the file is found. In embodiments, the client may be requested to send the file to the server for further analysis. In embodiments, the client sends the file to the server. In the embodiment, client handling of the file may end at this point depending on configuration. If there are multiple files to be processed, for the embodiment, the client would be expected to begin processing the next file.

Note that in embodiments, anti-virus server 110 may store the file contents in data file storage system 320. In embodiments, data file storage system 320 may store the file and return a unique file identifier. In embodiments, anti-virus server 110 may store the information about the file in a file information subsystem, such as for example, file information systems 315 of FIG. 2 along with the unique file identifier. In embodiments, virus scanner 325 may be notified of a new file and process the file. In embodiments, the actual processing algorithms may be algorithms known in the art. In embodiments, the results may include either identifying the file as infected or clean. The results, in an embodiment, may be passed back to file information system 315 and data file storage system 320. In embodiments, if the file is clean, no further processing or notifications may need to be done. In embodiments, if the file is infected, then the image information 315 may generate an infected file alert and ask communications systems 305 if FIG. 3 to send it to the client. In embodiments, the client may notify the user of the alert.

In another embodiment, a second example may be described below including a file new to the client but known to the server, such as for example, anti-virus server 110 of FIG. 1. In embodiments, to begin, a new file may be copied to the client. As noted previously, in embodiments, this can be the user downloading a picture, downloading a new application or other type of file. In embodiments, a source of the file is not important. In the embodiment, the client may perform initial processing on the file, such as for example, including gathering a name, path, size, creation date, and generating a signature. In embodiments, a purpose of the signature may be to detect subtle changes to a file that might not change the size of a file and to make it easy for the server to tell if two versions of a file are identical without doing a bit-wise comparison. Example signatures could be CRCC, MD-5 or SHA-1. In embodiments, the client may take information gathered and send it to the server for analysis. For the embodiment, the server may receive the information and determine if it has a copy of the file. In the embodiment, a file with a same name, size and signature may be reported to exist by data file storage system 320. In embodiments, a unique file key may be returned along with the virus information. In embodiments, results of the virus scan may be returned to the client. In embodiments, the file information may be stored in a device image storage system, such as image information 315.

In yet another embodiment, virus signature files may be updated. In embodiments, virus scanner 325 may begin scanning files stored in a file storage system such as, for example, data file storage system 320. In an embodiment, if a clean file is found to be infected, the information may be updated in both the data file storage system 320 and file information systems 315. In embodiments, file information 315 may generate alerts to be sent by communications systems 305 back to client for user action.

FIG. 4 and the accompanying discussion provide a description of a suitable computing environment in which embodiments can be implemented. Although not required, embodiments will be described in the general context of hardware and computer-executable instructions, such as program application modules, objects, or macros that are capable of being executed by a computer. FIG. 4 shows a computing system 400 and a network environment in which the computing system 400 may be used. The computing system 400 includes a computing device 460 and a server computing system 402. In various embodiments, computing system 400 may be a desktop computer, portable computer, or wireless device. In various embodiments, wireless device client 105 may include either wireless device 200 or computing system 400. The server computing system 402 may be located at one or more network locations, to store and serve information for the computing device 460 and other clients.

The computing device 460 may include a processing unit 404, a system memory 406, and a system bus 408 that couples various system components including the system memory 406 to the processing unit 404. The system memory 406 may be comprised of one or more computer readable media. The processing unit 404 may be any logic processing unit, such as one or more single or multi-core central processing units (CPUs), digital signal processors (DSPs), application-specific integrated circuits (ASICs), etc. The system bus 408 can employ any suitable bus structure or architecture, including a memory bus with memory controller, a peripheral bus, and a local bus. The system memory 406 includes read-only memory (ROM) 410 and random access memory (RAM) 412, or other volatile memory of the like. A basic input/output system (BIOS) 414, which can form part of the ROM 410, contains routines that help transfer information between elements within the computing device, such as during start-up.

Computing device 460 may include a hard disk drive 416, or other persistent storage, for reading from and writing to a hard disk 418. The hard disk drive 416 may communicate with the processing unit 404 via the system bus 408. The hard disk drive 416 may include interfaces or controllers (not shown) coupled between such drive(s) and the bus 408. The hard disk drive 416 and its associated hard disk 418 may provide nonvolatile storage of computer readable instructions, data structures, program modules and other data. Among these computer readable instructions, data structures, program modules and so forth are instructions, data structures and modules configured to implement one or more aspects of the earlier described anti-virus application described in connection with FIGS. 1, 2, and 3. Although the depicted computing device employs the hard disk drive 416 and the hard disk 418, other types of drives and computer-readable media that are capable of storing data accessible by a computer may be employed, such as compact disks (CDs), magnetic cassettes, flash memory cards, digital video disks (DVDs), Bernoulli cartridges, RAMs, ROMs, smart cards, etc. In one embodiment, the hard disk drive 416 and/or other drives are not integrated within a housing of the computing device 460 itself, but instead are external devices that are accessible via hardwire or wireless communication interfaces.

Program modules can be stored in the system memory 406, such as an operating system 420, one or more application programs 422, other programs or modules 424, and program data 426. An example operating system 420 that may be used is Windows Server 2008™ commercially available from Microsoft Corporation of Redmond, Wash. The program data 426 can be stored as a data structure, file, or other data format in a cache, database, or other storage unit integrated in or separate from the system memory 406.

The computing device 460 may also include a web browser 428 for permitting the computing device 460 to access and exchange data with sources such as Internet web sites, corporate intranets, or other networks as described below, as well as other server applications on server computers. While shown in FIG. 4 as being stored in the system memory 406, the operating system 420, application programs 422, other programs/modules 424, program data 426, and browser 428 can be stored in the hard disk 418 of the hard disk drive 416 and/or other computer-readable media.

A user can enter commands and information into the computing device 460 through input devices (such as the keyboard 411) and a pointing device such as a mouse 430. Alternatively or additionally, the mouse 430 can be embodied as a touch pad as compared to physical buttons. Another input device may take the form of one or more buttons 432 on the side of the keyboard 110, with the button(s) 432 usable for scrolling and clicking via turning and pressing of the button(s) 432. Other possible input devices can include a microphone, joystick, game pad, scanner, etc. (not shown). These and other input devices may be connected to the processing unit 404 through an interface 434 such as a serial port interface that couples to the bus 408, although other interfaces such as a parallel port, a game port or a wireless interface or a universal serial bus (USB) can be used. The interface 434 can be any suitable communication interface to the bus 408 and need not necessarily be a port per se.

The display screen 468 may operate as the main display and is coupled to the bus 408 via a graphics interface 436, such as a video adapter or other graphics component that will allow video and other graphics to be rendered on the display screen 468. The computing device 460 can operate in a networked environment using logical connections to one or more networked computers and/or devices, such as the server computing system 402 and a network device 440, such as a printer or network storage unit. The computing device 460 may be logically connected to one or more networked computing systems or devices under any suitable method of permitting computers to communicate, such as through a wireless local area network (LAN) 442, a wireless wide area network (WWAN), or any other network 444, including wired and wireless networks that use or can communicate with the Internet (e.g., World Wide Web). Other embodiments may include other types of communication networks including telecommunications networks, cellular networks, paging networks, and other mobile networks. Examples of wireless systems and protocols with which the computing device 460 can communicate, include but are not limited to, Wi-Fi, Bluetooth, 802.11, and others.

When used in a LAN networking environment, the computing device 460 can be connected to the LAN 442 through an adapter or network interface 446 (communicatively linked to the bus 408). When used in a WWAN or other network 444, the computing device 460 may include a modem, transceiver 448 or other device, such as the network interface 446, for establishing communications over this networking environment. The transceiver 448 as shown in FIG. 4 may be communicatively linked between the interface 434 and the network 444, for communicating between the computing device 460 and the server computing system 402, for instance.

In one embodiment, the computing device 460 may be communicatively linked to the server computing system 402 through the LAN 442 and/or the network 444 with transmission control protocol/Internet protocol (TCP/IP) middle layer network protocols or other network protocol layers, such as User Datagram Protocol (UDP). The network connections shown in FIG. 4 are only some examples of establishing communication links between computers, and other links can be used, including both hardwire and wireless links.

The server computing system 402 (which can comprise a hardware computing system, software computing system, or combination of both) includes one or more servers 450. A server can provide anti-virus services may comprise hardware, software, firmware, or combinations thereof that provide such files and services, including for example, a single hardware server that runs multiple server software. The server 450 can include one or more processing units 452, which can comprise CPUs, controllers, processors, and the like, that work in conjunction with server applications for the routing of financial transaction information between the computing device 460 (and other clients) and the server computing system 402. Server computing system may comprise systems or modules such as those described in conjunction with FIG. 3.

Although specific embodiments have been illustrated and described herein for purposes of description of the preferred embodiment, it will be appreciated by those of ordinary skill in the art that a wide variety of alternate and/or equivalent implementations may be substituted for the specific embodiment shown and described without departing from the scope of the present invention. Those with skill in the art will readily appreciate that the present invention may be implemented in a very wide variety of embodiments. This application is intended to cover any adaptations or variations of the embodiments discussed herein.

What is claimed is:

1. A computing device comprising:
a communication interface;
one or more storage media having a plurality of instructions; and
a processing unit coupled to the communication interface and the one or more storage media;
wherein the instructions, in response to execution by the processing unit, cause the computing device to
analyze files transmitted by a mobile device to the computing device for backup to determine whether at least one of the files is infected by a virus; and
perform one or more remedial actions, in response to a result of the determination that indicates at least one of the files is infected by a virus.

2. The computing device of claim 1, wherein the one or more remedial actions includes:
transmission of a notification that informs the mobile device of the at least one of the files determined to be infected by a virus; or
transmission of a notification to the mobile device to disable usage and/or execution of the at least one of the files determined to be infected by a virus.

3. The computing device of claim 1, wherein the one or more remedial actions includes:
transmission to the mobile device, a clean version of the at least one of the files determined to be infected by a virus; and
transmission to the mobile device, instructions that cause the mobile device to replace the at least one of the files determined to be infected by a virus with the clean version.

4. The computing device of claim 3, wherein the one or more remedial actions includes retrieval of the clean version of the at least one of the files determined to be infected by a virus from a previous backup of the at least one of the files determined to be infected by a virus, when the clean version is available.

5. The computing device of claim 3, wherein the one or more remedial actions includes disinfection of the at least one of the files determined to be infected by a virus to generate the clean version, when the clean version is not already available.

6. The computing device of claim 1, wherein the virus comprises malware.

7. At least one machine-readable storage medium comprising instructions, which in response to execution by a computing device, configure the computing device to:
analyze files transmitted by a mobile device to the computing device for backup to determine whether at least one of the files is infected by a virus; and
perform one or more remedial actions, in response to a result of the determination that indicates at least one of the files is infected by a virus.

8. The at least one machine-readable storage medium of claim 7, wherein the one or more remedial actions includes:
transmission of a notification that informs the mobile device of the at least one of the files determined to be infected by a virus; or
transmission of a notification to the mobile device to disable usage and/or execution of the at least one of the files determined to be infected by a virus.

9. The at least one machine-readable storage medium of claim 7, wherein the one or more remedial actions includes:
transmission to the mobile device, a clean version of the at least one of the files determined to be infected by a virus; and
transmission to the mobile device, instructions that cause the mobile device to replace the at least one of the files determined to be infected by a virus with the clean version.

10. The at least one machine-readable storage medium of claim 9, wherein the one or more remedial actions includes retrieval of the clean version of the at least one of the files determined to be infected by a virus from a previous backup of the at least one of the files determined to be infected by a virus, when the clean version is available.

11. The at least one machine-readable storage medium of claim 9, wherein the one or more remedial actions includes disinfection of the at least one of the files determined to be infected by a virus to generate the clean version when the clean version is not already available.

12. The at least one machine-readable storage medium claim 7, wherein the virus comprises malware.

13. A method comprising:
analyzing, by a computing device, files transmitted by a mobile device to the computing device for backup to determine whether at least one of the files is infected by a virus; and
performing, by the computing device, one or more remedial actions, in response to determining that at least one of the files is infected by a virus.

14. The method of claim 13, wherein the one or more remedial actions includes:
transmitting, by the computing device, a notification informing the mobile device of the at least one of the files determined to be infected by a virus; or
transmitting, by the computing device, a notification to the mobile device to disable usage and/or execution of the at least one of the files determined to be infected by a virus.

15. The method of claim 13, wherein the one or more remedial actions includes:
transmitting, by the computing device, a clean version of the at least one of the files determined to be infected by a virus to the mobile device; and
transmitting, by the computing device, instructions, to the mobile device, that cause the mobile device to replace the at least one of the files determined to be infected by a virus with the clean version.

16. The method of claim 15, wherein the one or more remedial actions includes retrieving the clean version, of the at least one of the files determined to be infected by a virus, from a previous backup, of the at least one of the files determined to be infected by a virus, when the clean version is available.

17. The method of claim 15, wherein the one or more remedial actions includes disinfecting of the at least one of the files determined to be infected by a virus to generate the clean version, when the clean version is not already available.

18. The method of claim 13, wherein the virus comprises malware.

19. A computing device comprising:
a communication interface;
one or more storage media having a plurality of instructions; and
a processing unit coupled to the communication interface and the one or more storage media;
wherein the instructions, in response to execution by the processing unit, cause the computing device to:
receive a file transmitted by a mobile device;
analyze the received file to determine whether the file has been infected by a virus; and
notify the mobile device of the infected file when a virus is present in the received file.

20. The computing device of claim 19, wherein the instructions, in response to execution by the processing unit, further cause the computing device to:
clean a file that has been determined to be infected by a virus;
send the cleaned file to the mobile device; and
send instructions that cause the mobile device to replace the infected file with the clean file.

21. The computing device of claim 19, wherein the instructions, in response to execution by the processing unit, further cause the computing device to:
retrieve a clean version of the infected file from a previous backup of the mobile device, when the clean version is available.

22. A method comprising:
receiving a file, by the computing device, transmitted from a mobile device;
analyzing the file, by the computing device, to determine whether the file has been infected by a virus; and
sending, by the computing device, a notification of the infected file to the mobile device, when a result of the determination indicates the file has been infected by a virus.

23. The method of claim 22, further comprising:
cleaning, by the computing device, a file that has been determined to be infected by a virus;
sending, by the computing device, the cleaned file to the mobile device; and
sending, by the computing device, instructions to cause the mobile device to replace the infected file with the clean file.

24. The method of claim 22, further comprising:
retrieving, by the computing device, a clean version of the infected file from a previous backup of the mobile device, when the clean version is available.
